(19) United States
(12) Patent Application Publication
(10) Pub. No.: US 2002/0118922 A1
(43) Pub. Date: Aug. 29, 2002

(54) Fiber grating temperature compensation package

(76) Inventor: Pin Long, LaSalle (CA)

Correspondence Address: Pin Long, c/o PROTECTIONS EQUINOX INT'L INC., Suite 224, 4480, Cote-de-Liesse, Ville Mont-Royal, QC, H4N 2R1, CA

(21) Appl. No.: 09/791,549

(22) Filed: Feb. 26, 2001

(51) Int. Cl. G02B 6/34; G02B 6/36

(52) U.S. Cl. 385/37; 385/99; 385/137

(57) ABSTRACT

An invention proposes a new solution for the optical fiber gratings temperature compensation package that has an elongated body made out of a low coefficient of thermal expansion (CTE) material with a longitudinal internal passage therethrough and that transversely extends to a perimeter of the body all along between its first and second extremities and forms a longitudinal exterior opening. The latter allows the optical fiber to be transversely inserted therethrough and to be fixed in a stretched configuration to a first and second end pieces made out of a high CTE material and longitudinally slidably mounted on a respective of first and second extremities of the body.

### FIELD OF THE INVENTION

The present invention relates to temperature compensation devices and more particularly, to a temperature compensation packages for grating areas of optical fibers.

### BACKGROUND OF THE INVENTION

A fiber grating has many applications including band rejection filter, semiconductor laser stabilizer, fiber laser wavelength selector, fiber amplifier reflector, fiber dispersion compensation, Drop Wavelength Division Multiplex (DWDM) and drop multiplex, light pulse shape reforming, optical fiber switch, optical sensor and other. Very often it is necessary using a temperature compensation package for the grating area of the fiber.

Concept and working principle of most popular temperature compensation packages is the usage of two type materials to package fiber gratings. The optical fiber located inside longitudinal packaging body, usually a tube made of very low coefficient of thermal expansion (CTE) material, such as quartz or invar, being stretched between two end pieces with high CTE material, such as aluminum, brass, copper, stainless steel or the like, located on both ends of that tube. When temperature increases, the length of the two end pieces with high CTE increases, the tension inside the fiber reduces and the fiber grating pitch decreased which will compensate the wavelength change of the fiber grating due to the increase of the optical fiber index.

Using an ordinary tube creates many problems in assembling the temperature compensation package.

Operators and robotic systems may experience difficulties in accurately inserting epoxy inside such a temperature compensation device for securing the fiber grating area inside the tube in a strained position. Process of inserting the fiber through the tube and then applying the tension on the fiber grating is very difficult and the optical fiber with fiber grating can be easily broken during this process. At the same time this process is very long and time consuming thus increasing the cost of the compensation device. This is a great limitation of the currently used compensation devices.

### OBJECTS OF THE INVENTION

An object of the present invention to provide a fiber grating temperature compensation package that obviates the above mentioned disadvantages.

Another object of the present invention is to provide a fiber grating temperature compensation package that allows for easy insertion of an optical fiber into and along an elongated body.

A further object of the present invention is to provide a fiber grating temperature compensation package that allows an operator to easily insert epoxy with a substantial accuracy.

Still another object of the present invention is to provide a fiber grating temperature compensation package which allows for effective control of the induced tension of the optical fiber during its assembling.

Still further object of the present invention is to provide a fiber grating temperature compensation package that allows for low time consuming assembly process.

Other objects and advantages of the present invention will become apparent from a careful reading of the detailed description provided herein, with appropriate reference to the accompanying drawings.

### SUMMARY OF THE INVENTION

According to one aspect of the present invention, there is provided a fiber grating temperature compensation package that comprises an elongated body that has a longitudinal internal passage therethrough for receiving a grating area of an optical fiber therein, a first and second end pieces longitudinally slidably mounted on a respective first and second extremity of the body for securing the fiber in a stretched configuration therebetween and each having an extending section freely engaging the passage. The passage transversely extends to a perimeter of the body all along between extremities of the same and forming a longitudinal exterior opening. That opening allows for the optical fiber to be transversely inserted therethrough and to be fixed in the stretched configuration to the first and second end pieces using an adhesive means. The elongated body and end pieces are made out of materials with generally low and high coefficient of thermal expansion (CTE) respectively.

Preferably, the adhesive means is an epoxy resin.

Preferably, the elongated body is a hollowed body.

Alternatively, the elongated body has a generally solid cross section.

Preferably, the elongated body has a cylindrical shape.

Alternatively, the elongated body has a polygonal shape.

Alternatively, the extending section of the first and second end pieces extends toward each other to form a common end piece.

According to a second aspect of the present invention, the fiber grating temperature compensation package comprises an elongated body that has a longitudinal internal passage therethrough for receiving a grating area of an optical fiber therein, a first and second end pieces longitudinally slidably mounted on a respective first and second extremity of the body for securing the fiber in a stretched configuration therebetween and each having an extending section freely engaging the passage. The passage transversely extends to a perimeter of the first extremity of the body and forms a regional longitudinal exterior opening. That opening allows for the optical fiber to be fixed in the stretched configuration to the first piece using an adhesive means. The elongated body and end pieces are made out of materials with generally low and high coefficient of thermal expansion respectively.

Preferably, the passage transversely extending to a perimeter of said body at said second extremity of the same and forming a second regional longitudinal exterior opening, said second opening allowing for said optical fiber to be fixed in said stretched configuration to said second end piece using an adhesive means.

### BRIEF DESCRIPTION OF THE DRAWINGS

In the annexed drawings, like reference characters indicate like elements throughout.

FIG. 1 is a perspective view of an embodiment of a fiber grating temperature compensation package according to the present invention;

FIG. 2 is a perspective view of the elongated body of the embodiment of FIG. 1;

FIG. 3 is a view similar to FIG. 2, showing an elongated body with polygonal shape;

FIG. 4 is a view similar to FIG. 1, showing a second embodiment of a fiber grating temperature compensation package;

FIG. 5 is a view similar to FIG. 2, showing a second embodiment of an elongated body;

FIG. 6 is a view similar to FIG. 5, showing an elongated body with polygonal shape;

FIG. 7 is a view similar to FIG. 2, showing an elongated body having a generally solid cross section;

FIG. 8 is a view similar to FIG. 7, showing an elongated body with polygonal shape; and

FIG. 9 is a view similar to FIGS. 1 and 4, showing the two end pieces being joined to each other and form a common piece.

### DETAILED DESCRIPTION OF THE PREFERRED EMBODIMENTS

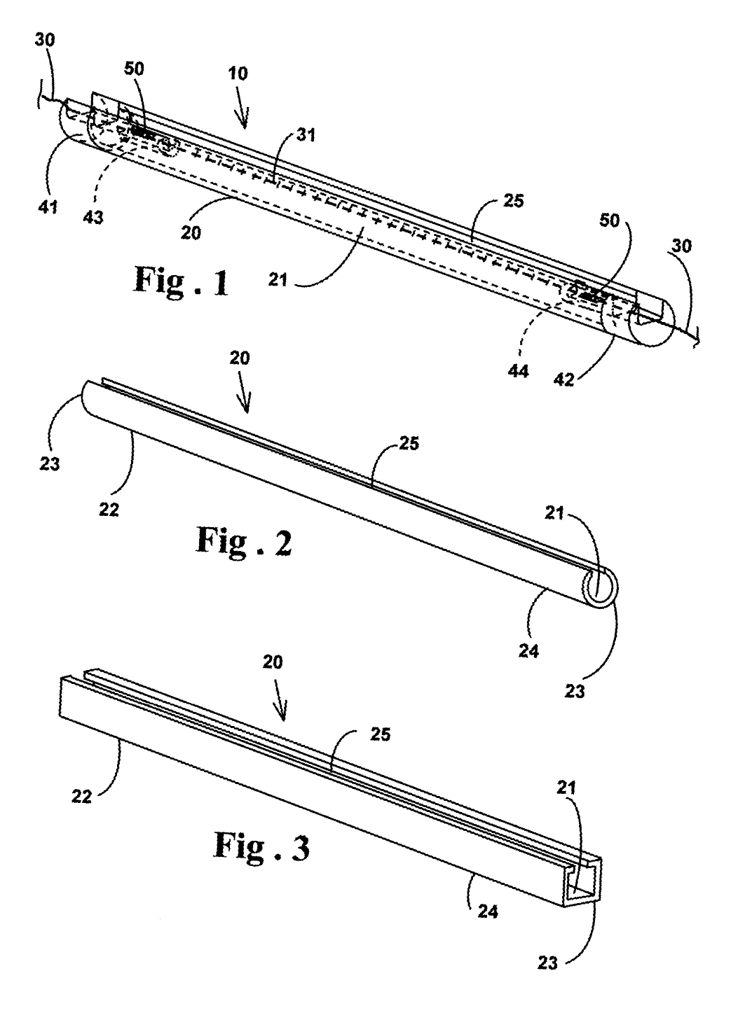

Referring to FIGS. 1, there is shown an embodiment 10 of a fiber grating temperature compensation package according to the present invention. The package 10 includes an elongated body 20 made out of a low coefficient of thermal expansion (CTE) material, such as quartz or invar. As shown in FIGS. 1 and 2, the body 20 has a longitudinal internal passage 21 therethrough for receiving a grating area 31 of an optical fiber 30 therein. First 41 and second 42 end pieces longitudinally slidably mounted on a respective first 22 and second 24 extremity of the body 20 for securing the fiber 30 in a stretched configuration therebetween. Each piece 41 and 42 has an extending section 43 and 44 freely engaging the passage 21. The passage 21 transversely extends to a perimeter 23 of the body 20 all along between extremities 22 and 24 of the same 20 and forms a longitudinal exterior opening 25. The opening 25 allows for the optical fiber to be transversely inserted therethrough and to be fixed in the stretched configuration to first and second end pieces 41 and 42 using an adhesive means 50, preferably an epoxy resin or the like material. End pieces 41 and 42 are made out of a material with generally high CTE, such as aluminum, brass, copper, stainless steel or the like.

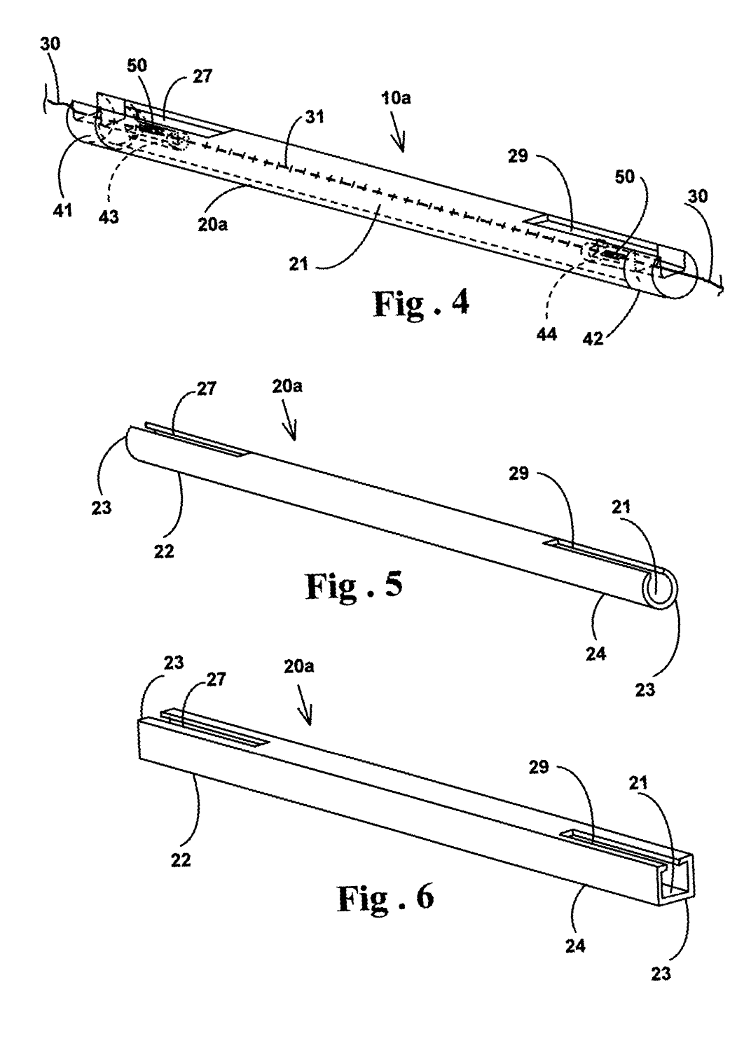

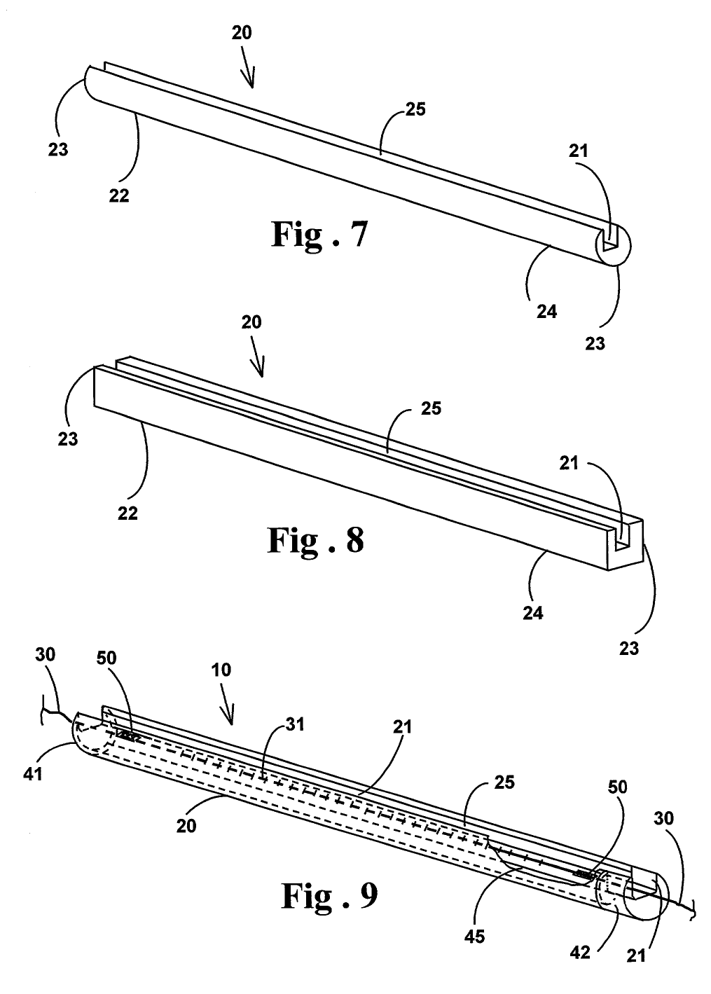

Referring to FIGS. 1 to 6, the elongated body 20 is a hollowed body or, as shown in FIGS. 7 to 9, has a generally solid cross section.

Preferably, the elongated body 20 has a cylindrical shape (see FIGS. 1, 2, 4, 5, 7 and 9) or a polygonal shape (see FIGS. 3, 6 and 8).

As illustrated in FIG. 9, extension sections 43 and 44 of first and second end pieces 41 and 42 extend toward each other to form a common end piece 45. In this case it is preferred that the common piece 45 is secured to only one of extremities 22 or 24 of the body 20.

With reference to FIGS. 4, 5 and 6, there is shown a second embodiment 10a of present invention in which the elongated body 20a has a longitudinal internal passage 21 therethrough for receiving a grating area 31 of an optical fiber 30 therein. The passage 21 transversely extends to a perimeter of the first extremity 22 of the body 20a and forms a regional longitudinal exterior opening 27. The opening 27 allows for the optical fiber 30 to be fixed in stretched configuration to the first end piece 41 using an adhesive means such as epoxy 50. Preferably, the passage also transversely extends to the perimeter of the body 20a at its second extremity 24 and forms a second regional longitudinal exterior opening 29. The second opening 29 allows for the optical fiber 30 to be fixed in the stretched configuration to the second end piece 42 using the epoxy resin 50.

The present invention is very easy to assemble, strong in safely and securely holding longitudinal optical fiber grating area 31 along the temperature compensation package 10 in a strained position.

The optical fiber 30 with fiber grating 31 can be put inside the elongated body 20 through longitudinal exterior opening 25 or inside the elongated body 20a through regional longitudinal exterior opening 27 and/or 29 very easily. After applying tension on the optical fiber 30, the securing member 50, preferably a standard epoxy material, is also very easily applied at the location of end pieces 41 and 42, preferably on the extending section 43 and 44 of the same. When the epoxy 50 is fully cured, another stainless or plastic tube (not shown) can be put for embracing the temperature compensation package 10 or 10a.

Although the present temperature compensating device 10 has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A fiber grating temperature compensation package comprising an elongated body having a longitudinal internal passage therethrough for receiving a grating area of an optical fiber therein, a first and second end pieces longitudinally slidably mounted on a respective first and second extremity of said body for securing said fiber in a stretched configuration therebetween and each having an extending section freely engaging said passage, said passage transversely extending to a perimeter of said body all along between said extremities of the same and forming a longitudinal exterior opening, said opening allowing for said optical fiber to be transversely inserted therethrough and to be fixed in said stretched configuration to said first and second end pieces using an adhesive means, said elongated body and end pieces being made out of materials with generally low and high coefficient of thermal expansion respectively.

2. A package as defined in claim 1, wherein said adhesive means is an epoxy resin.

3. A package as defined in claim 1, wherein said elongated body being a hollowed body.

4. A package as defined in claim 1, wherein said elongated body having a generally solid cross section.

5. A package as defined in claim 1, wherein said elongated body having a cylindrical shape.

6. A package as defined in claim 1, wherein said elongated body having a polygonal shape.

7. A package as defined in claim 1, wherein said extension section of said first and second end pieces extending toward each other to form a common end piece.

8. A fiber grating temperature compensation package comprising an elongated body having a longitudinal internal passage therethrough for receiving a grating area of an optical fiber therein, a first and second end pieces longitudinally slidably mounted on a respective first and second extremity of said body for securing said fiber in a stretched configuration therebetween and each having an extending section freely engaging said passage, said passage transversely extending to a perimeter of said first extremity of the same and forming a regional longitudinal exterior opening, said opening allowing for said optical fiber to be fixed in said stretched configuration to said first end piece using an adhesive means, said elongated body and end pieces being made out of materials with generally low and high coefficient of thermal expansion respectively.

9. A package as defined in claim 8, wherein said passage transversely extending to a perimeter of said body at said second extremity of the same and forming a second regional longitudinal exterior opening, said second opening allowing for said optical fiber to be fixed in said stretched configuration to said second end piece using an adhesive means.

10. A package as defined in claim 8 wherein said adhesive means is an epoxy resin.

11. A package as defined in claim 8 wherein said elongated body being a hollowed body.

12. A package as defined in claim 8 wherein said elongated body having a generally solid cross section.

13. A package as defined in claim 8 wherein said elongated body having a cylindrical shape.

14. A package as defined in claim 8 wherein said elongated body having a polygonal shape.

15. A package as defined in claim 8 wherein said extending section of said first and second end pieces extending toward each other to form a common end piece.
